(19) United States
(12) Patent Application Publication
(10) Pub. No.: US 2016/0127456 A1
(43) Pub. Date: May 5, 2016

(54) MUSICAL COMPOSITION AND PRODUCTION INFRASTRUCTURE

(71) Applicant: Humtap Inc., San Francisco, CA (US)

(72) Inventors: Tamer Rashad, Mountain View, CA (US); Serkan Kalyoncu, Berlin (DE); Leigh Smith, New York, NY (US)

(21) Appl. No.: 14/932,893

(22) Filed: Nov. 4, 2015

Related U.S. Application Data
(63) Continuation-in-part of application No. 14/920,846, filed on Oct. 22, 2015.
Application No. 14/920,846 is a continuation of application No. 14/931,740, filed on Nov. 3, 2015.
Application No. 14/931,740 is a continuation-in-part of application No. 62/074,542, filed on Nov. 3, 2014.
(60) Provisional application No. 62/067,012, filed on Oct. 22, 2014.
(60) Provisional application No. 62/075,160, filed on Nov. 4, 2014.

(51) Int. Cl. H04L 29/08; H04L 29/06

(52) U.S. Cl. CPC H04L 67/1002; H04L 67/42; H04L 67/02; G10H 2240/175

(57) ABSTRACT

Disclosed is a system infrastructure that allows for the online and social creation of music and musical thoughts in real-time or near real-time by amateurs and professionals. Individual musical contributions are combined into a single, cohesive musical thought that is presented for approval to the collaborating creators. This solution is extensible from the world of music to other creative endeavors including the written word, video, and digital images. The foregoing system infrastructure powers and supports the online and social creation of music and musical thoughts in real-time or near real-time by amateurs and professionals alike.

### CROSS-REFERENCE TO RELATED APPLICATIONS

The present application is a continuation-in-part and claims the priority benefit of U.S. patent application Ser. No. 14/920,846 filed Oct. 22, 2015, which claims the priority benefit of U.S. provisional application No. 62/067,012 filed Oct. 22, 2014; the present application is also a continuation-in-part and claims the priority benefit of U.S. patent application Ser. No. 14/931,740 filed Nov. 3, 2015, which claims the priority benefit of U.S. provisional application No. 62/074,542 filed Nov. 3, 2014; the present application also claims the priority benefit of U.S. provisional application No. 62/075,160 filed Nov. 4, 2014. The disclosure of each of the aforementioned applications is incorporated herein by reference.

### BACKGROUND OF THE INVENTION

1. Field of the Invention

The present invention generally relates to the creation of musical content. More specifically, the present invention relates to a system infrastructure that allows for the social composition and production of music and musical thoughts in real-time or near real-time.

2. Description of the Related Art

The music industry generates tens of billions of dollars on an annual basis. Contributing to this multi-billion dollar industry are any number of “players” or “industries within the industry.” Artists and other creative talents generate musical content for performance and distribution. Content providers and distributors make this musical content available to consumers for enjoyment through traditional record and compact disc sales as well as downloadable services such as iTunes and streaming services such as Spotify. Intermediate “middleware” providers such as Gracenote are now a critical part of the music industry ecosystem. These providers offer a wide variety of services including music recognition technologies, metadata, and any number of other identification, discovery, and connection services.

Notwithstanding the existence and financial success of multiple contributors and multiple strata of the music industry, social media remains an unnaturally silent partner For example, there is no social medium for the online creation of music in real time by amateurs or professionals. Messaging has mediums such as Twitter and Facebook; still visual images (e.g., digital photography) have Instagram and Flickr; and video content has Vine and YouTube. But there is no equivalent medium for music nor is there a social venue allowing for collaborative digital musical content creation in real-time or near real-time.

There is a need in the art for a system and method that allows for the social composition and production of music and musical thoughts in real-time or near real-time by both amateurs and professionals. There is a corresponding need for a musical composition and production infrastructure to support the aforementioned social creation of music and musical thoughts.

### SUMMARY OF THE PRESENTLY CLAIMED INVENTION

A first claimed embodiment concerns a system for developing musical content. The system includes a front-end application executing on a computing device and that provides a musical contribution. The system also includes an API server that receives a musical contribution from the front-end application and that generates a job ticket for creation of social co-created musical content. The system further includes a messaging server that receives the job ticket from the API server and is communicatively coupled to the database, composition server, and production server. The system also includes a database that maintains the musical contribution from the front-end application, data related to the generation of the musical contribution, musical blueprints, and rendered musical content all associated within a job ticket from the messaging server. A composition server creates a musical blueprint using the musical contribution and a production server renders musical content using the musical blueprint, the rendered musical content is provided through the front-end application for playback and interaction.

### BRIEF DESCRIPTION OF THE DRAWINGS

FIG. 1 illustrates a musical composition and production infrastructure to support social creation of music and musical thoughts.

FIG. 2 illustrates the multiple tiers and subnets of the musical composition and production infrastructure of FIG. 1. FIG. 3 illustrates a processing methodology that may be executed by the musical composition and production infrastructure of FIGS. 1 and 2.

FIG. 4 illustrates an exemplary computing device that may be used in the various tiers illustrated in FIG. 2.

### DETAILED DESCRIPTION

Embodiments of the present invention provide an infrastructure that allows for social composition and production of musical thoughts in real-time or near real-time by both amateurs and professionals. Embodiments of the present invention may be utilized to allow for the combination of individual musical contributions into single, cohesive musical thoughts. These musical thoughts may be presented to collaborating creators or another audience for approval, refinement, or further derivation. The present invention may be extended to other creative endeavors including but not limited to the written word, video, and digital imagery.

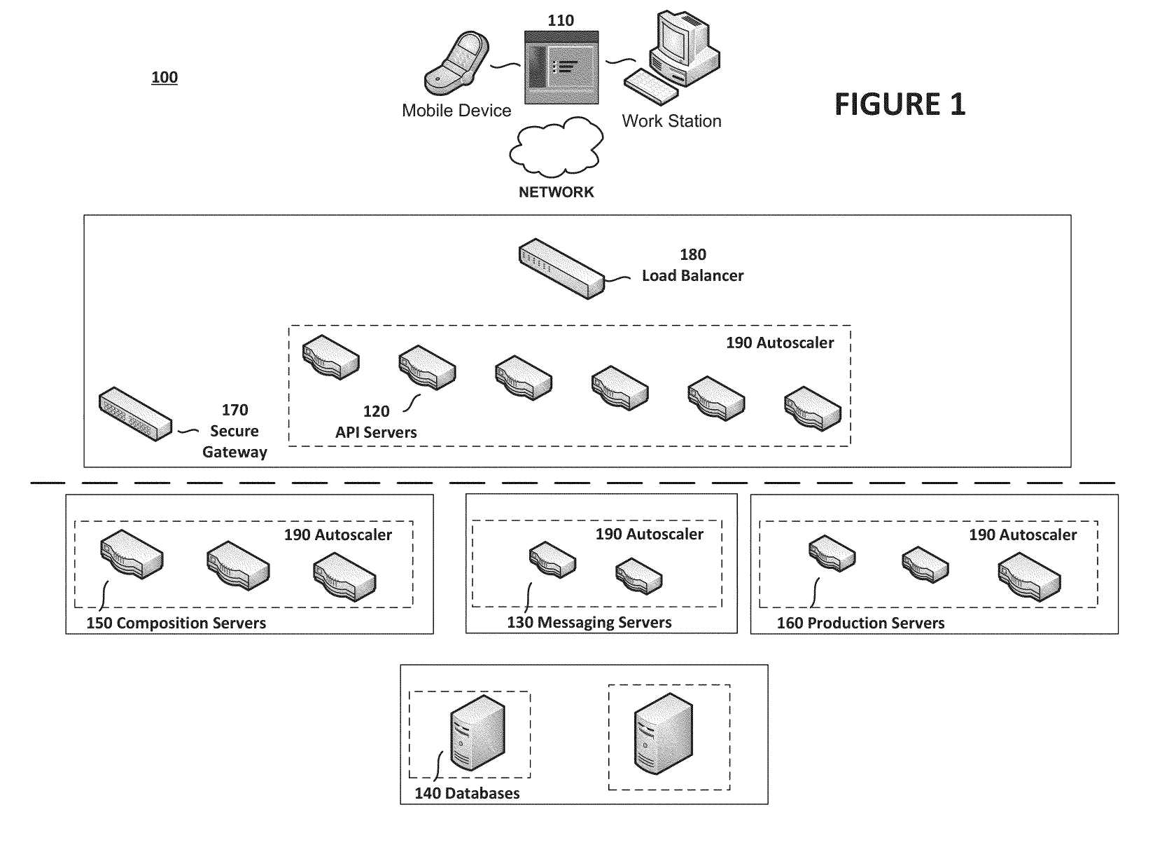

FIG. 1 illustrates a musical composition and production infrastructure 100 to support social creation of music and musical thoughts. The system infrastructure 100 of FIG. 1 illustrates a mobile device and workstation. Each device may host, execute, and allow for the operation of a front end application 110 that may communicate over a network with the various tiers and components of said tiers as further described herein. FIG. 1 also illustrates application programming interface (API) servers 120, messaging servers 130, and database servers 140. FIG. 1 also includes composition servers 150 and production servers 160. Optional infrastructure elements in FIG. 1 include a secure gateway 170, load balancer 180, and autoscalers 190.

The front end application 110 operating on mobile devices and work stations as illustrated in FIG. 1 provides an interface to allow users to make social contributions to a collaborative and socially co-created musical thought. For example, a first and second user may offer their individual social contributions of musical thoughts. These contributions are inclusive of a melodic “hum,” a rhythmic “tap” or “taps,” a melodic “hum” responsive to a rhythmic “tap” or “taps,” a rhythmic “tap” or “taps” responsive to a melodic “hum,”or a musical thought responsive to an already existing musical collaboration.

Such social contributions of musical thought may occur on a mobile device as might be common amongst amateur or non-professional content creators. Social contributions may also be provided at a professional workstation or server system executing an enterprise version of the application 110 as might be more common amongst music or industry professionals. The front end application 110 connects to the API server 120 over a wired, wireless, or heterogeneous communication network that may be public, proprietary, or a combination of the foregoing.

The API server 120 of FIG. 1 is a standard hypertext transfer protocol (HTTP) server that can handle API requests from the front end application 110. The API server 120 of FIG. 1 can use common HTTP web server frameworks and languages such as Python, Tornado, or Apache. The API server 120 of FIG. 1 may utilize the Representational State Transfer (REST) architectural style of Service Oriented Architecture (SOA). The REST architectural style consists of a coordinated set of architectural constraints applied to components, connectors, and data elements within a distributed HTTP system.

The API server 120 of FIG. 1 listens for and responds to requests from the front end application 110, including but not limited to the submission of and contribution to musical thoughts from multiple users (e.g., “hums” and “taps”). Upon receipt of a request to commence generation or contribute to the generation of a socially co-created musical thought, a job or “ticket” is created that is passed to the messaging servers 130 of FIG. 1. Once a messaging server 130 is provided with a job ticket from the API server 120, the API server 120 is free to eliminate any state from the front end application 110 interaction.

Messaging server 130 of FIG. 1 is an advanced message queuing protocol (AMQP) message broker, such as the RabbitMQ framework. The Messaging servers 130 allow for communication between the various back-end components of the infrastructure 100 via message queues. Multiple messaging servers 130 may be run using an autoscaler 190 to ensure messages are handled with minimized delay.

Database servers 140 provide storage for infrastructure 100. Database 140 maintains instances of user musical thoughts from various users such as “hums” and “taps.” Such musical thoughts may be stored on web accessible storage services such as the Amazon Web Services (AWS) Simple Storage Service (AWS S3) whereby the database server 140 stores web accessible addresses to sound and other data files representing those musical thoughts. Database 140 may also maintain user information, including but not limited to user profiles and data associated with those profiles, including user tastes, search preferences, and recommendations. Database 140 may also maintain information concerning genres, compositional grammar rules and styles as might be used by composition server 150 and instrumentation information as might be utilized by production server 160.

Database 140 may further maintain executable files and information related to music information retrieval (MIR). MIR files might include extraction tools that process “hums” and peak detection for identifying “taps.” Database 140 can also correlate tickets to various data elements. For example, database 140 identifies which “hums” relate to which “taps” by way of job tickets.

Composition server 150 “listens” for tickets that are queued by messaging server 130 and maintained by database 140. Such tickets reflect the need for execution of the composition and production process. Composition server 150 maintains a composition module that is executed to generate a musical blueprint that incorporates a “hum” and “tap” in the context of a given musical genre. Multiple tickets may be issued by the API server 120 to the composition server 150 to produce scores or blueprints for each hum or tap individually and store these in the database 140. The scores of a pair of “hums” and “taps” are then used by the composition server 150 to produce the score or blueprint for rendering to sound data by the production server 160.

The composition server 150 will next create rendering tickets on the messaging server 130. The production server 160 retrieves tickets for rendering and the score or blueprint as generated through the execution of the composition module. Production server 160 then applies instrumentation to the same. The end result of the composition process is maintained in database 140.

Production server 160 utilizes data in database 140 that corresponds to a given ticket and corresponding musical blueprints. Utilizing this information, production server 160 may render collaborative and socially co-created musical content such as the combination of a “hum” and “tap” in the context of a given genre. Production server 160 listens to a ticket queue on messaging server 130 and when a ticket identifies the need for rendering by the production server 160, the requisite data is acquired from the database 140 to allow for the rendering process to take place.

The rendered sound data is then provided from the production server 160 to the front end application 110 over network. Once received at the front end application 110 of a mobile device or workstation, the sound data may be played back or subjected to further manipulation or interaction. Such delivery may occur using web addressable storage such as AWS S3.

The rendered data is retrieved from API server 120 using the sound data file address stored in database server 140. Production server 160 may use dedicated hardware components to improve performance of the rendering processing. This dedicated hardware may include multiple very fast central processing units (CPU), dedicated digital signal processing (DSP) units, or graphics processing units (GPU).

FIG. 1 also illustrates optional load balancer 180. Load balancer 180 acts as a reverse proxy and distributes network or application traffic across a number of duplicate API servers 120. Load balancer 180 operates to increase the capacity (i.e., concurrent users) and reliability of applications like front end application 110 that interact with overall network infrastructure 100. Load balancer 180 decreases the burden on the API servers 120 associated with managing and maintaining front end application 110 and network sessions as well as by performing application-specific tasks. Load balancer 180 may be a Layer 4 balancer that acts upon data found in network and transport layer protocols such as Internet Protocol, Transmission Control Protocol, File Transfer Protocol, and the aforementioned UDP. Layer 7 load balancers distribute requests based upon data found in application layer protocols such as HTTP.

The system infrastructure 100 illustrated in FIG. 1 also includes multiple instances of optional autoscaler 190. Autoscaler 190 helps maintain front end application 110 availability and allows for the automatic scaling of services (i.e., capacity) according to infrastructure administrator defined conditions. Autoscaler 190 can, for example, automatically increase the number of instances of composition 150, messaging 130 and production 160 servers during demand spikes to maintain performance and decrease capacity during lulls to reduce network infrastructure costs.

Load balancer 180 and autoscaler 190 may operate in conjunction with one another to help maintain optimal system infrastructure 100 operability. For example, load balancer 180 may help distribute traffic to specific instances of auto scaling groups. Those specific group instances may be managed by autoscaler 190. Alternatively, the use of the messaging server 130 enables the autoscaling of the composition and production servers to occur decided by the number of pending tickets in the messaging queues without requiring a load-balancer to distribute tickets to the composition 150 and production 160 servers.

The aforementioned system architecture may be implemented in a cloud computing environment. That environment may be hosted by a third-party like the aforementioned AWS cloud computing environment. A cloud computing environment allows for a simplified means of accessing servers, storage, databases and a broad set of application services over the Internet. Third-party hosts like AWS own and maintain the network-connected hardware required for these application services, while end-users provision and use specifically what is required to implement an service offering by means of a web application.

Various network protocols, architectures, and hosting arrangements have been described in the context of FIG. 1. It should be understood, however, that the foregoing are exemplary. Other protocols, architectures, and hosting arrangements may be implemented and as might be required by the scale or end deliverables of a particular social co-creation network architecture. The aforementioned protocols, architectures, and hosting arrangements should not be deemed as limiting.

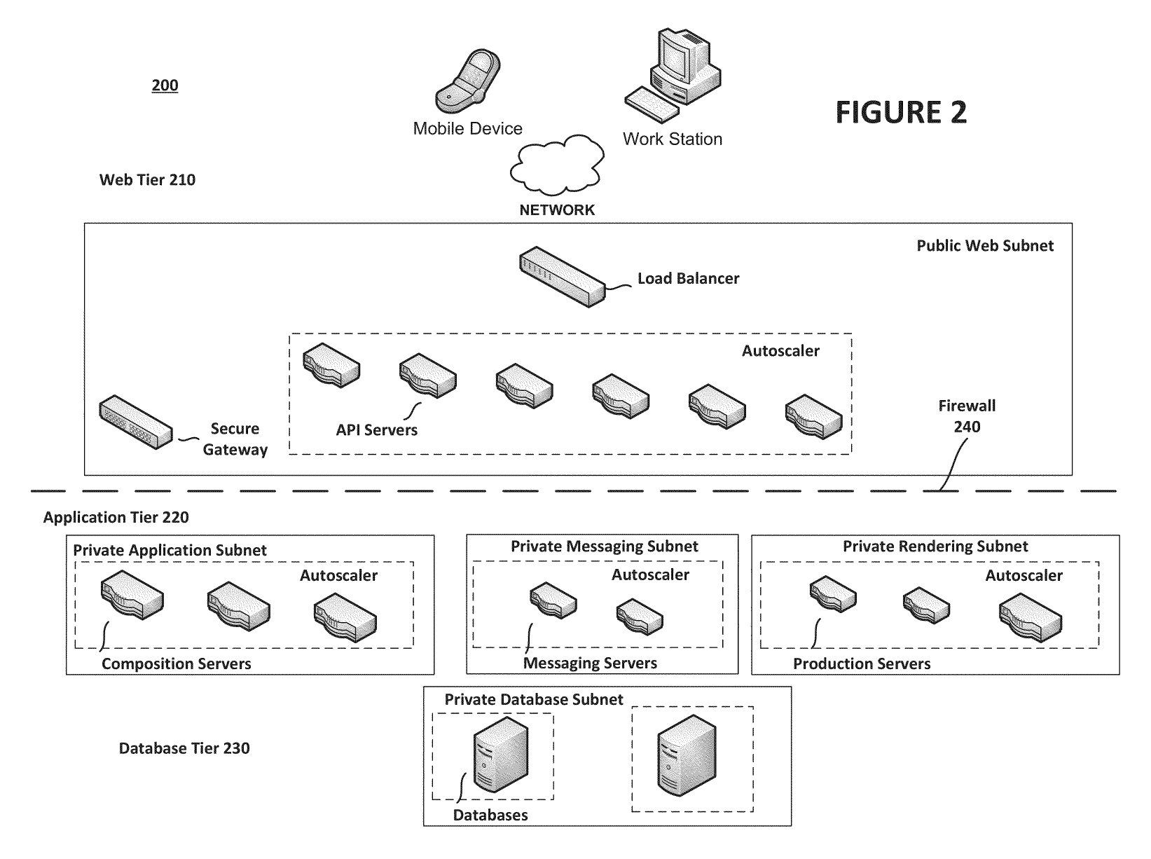

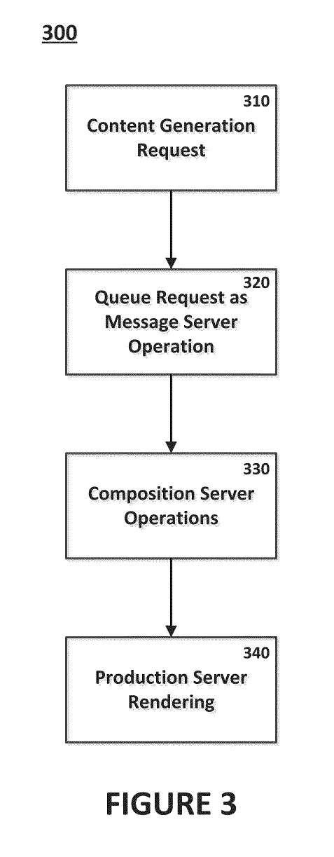

FIG. 2 illustrates the multiple tiers and subnets of the musical composition and production infrastructure of FIG. 1. More specifically, FIG. 2 illustrates components of the infrastructure 200 as three separate tiers: a web tier 210, application tier 220, and database tier 230. Separating the web tier 210 and both the application 220 and database tier 230 is firewall 240. Firewall 240 operates to control incoming and outgoing network traffic based on one or more applied rule sets. Firewall 240 establishes a barrier between a trusted, secure internal network like that illustrated with respect to the application tier 200 and database tier 230 and another network that is typically less secure and trusted like the Internet, which stands as part of the web tier 210.

The web tier 210 of FIG. 2 illustrates various API servers 120 as discussed in the context of FIG. 1. A load balancer 180 and autoscaler 190 are also illustrated as a part of the web tier 210. All of the foregoing are grouped as a part of the public web subnet, which falls on the unsecure side of firewall 240. The multiple API servers created within the public web subnet are limited, with respect to access, to the HTTP protocol. Outbound network traffic, in turn, is limited to the messaging and database subnets.

The application tier 220 of FIG. 2 falls on the secure side of the firewall 240 and illustrates various instances of a composition server, message server, and production server. The foregoing fall within private application, private messaging, and private rendering subnets, respectively. Multiple instances of of autoscalers are again disclosed albeit in the context of the application tier 220.

Also shown in FIG. 2 is the database tier 230, which consists of the private database subnet and corresponding databases as described in the context of FIG. 1. A failover database may be implemented as a part of the database tier 230. Failover database serves a redundant function to a primary database and may operate in accordance with any number of redundancy principles as are known to one of skill in the art in the field of network architectures and computer networking. Multiple database servers can also be used in separate sub networks to maintain database service availability under load and for redundancy for fault-tolerance.

FIG. 3 illustrates a processing methodology 300 that may be executed by the musical composition and production infrastructure of FIGS. 1 (100) and 2 (200). The method 300 of FIG. 3 involves a request for generation of a socially co-created musical work. Such a request comes by way of the API server 120 and front end application 110 in communication with the server 120 at step 310. The request is then queued at step 320 as an operation of the messaging server 130. The composition server 150 then draws from and generates to database 140 at step 330 in accordance with the queued request from step 320. Production and rendering takes places at step 340 responsive to the continued processing of messages in the queue. A sound file is generated and pushed back to the user by way of the API server 120 and front-end application 110. Notification of the completion of the rendering is indicated to the API server 120 via the messaging server 130.

Multiple versions of method 300 may be executed on a single computing device. Various elements of the processing chain may likewise be executed in parallel across multiple computing devices. For example, multiple compositional instances may be taking place at the same time of various instances of production alongside various instances of rendering. Further, multiple computing devices may allow for the parallel processing of multiple processing chains (i.e. method 300) or portions thereof on each of those computing devices at once. This processing chain 300 allows for asynchronous musical synthesis and creation of socially co-created musical content.

Various tools, which may be from a third-party, may be plugged into or integrated with various portions of the system infrastructure 100. Such integration may allow for a more cohesive operating environment and the creation of a common production framework. Data generated as a result of execution and utilization of such tools can be harvested and utilized to improve operation of composition, production, and rendering.

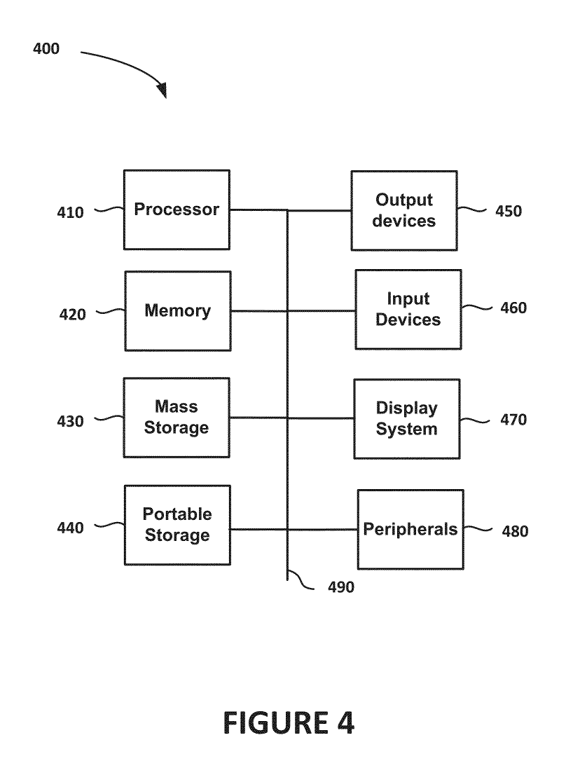

FIG. 4 illustrates an exemplary computing device 400 that may be used in the various tiers illustrated in FIG. 2. Hardware device 400 may be implemented as a client, a server, or an intermediate computing device. The hardware device 400 of FIG. 4 is exemplary. Hardware device 400 may be implemented with different combinations of components depending on particular system architecture or implementation needs.

For example, hardware device 400 may be utilized to implement musical information retrieval, composition, and production in a system architecture like that illustrated in FIGS. 1 and 2. Hardware device 400 might also be used at an application front end as might occur in a professional, studio implementation although other front end implementations are possible including at a mobile device. Composition, production, and rendering may occur on a separate hardware device 400 or could be implemented as a part of a single hardware device 400. Composition, production, and rendering may be individually or collectively software driven, part of an application specific hardware design implementation, or a combination of the two.

Hardware device 400 as illustrated in FIG. 4 includes one or more processors 410 and non-transitory memory 420. Memory 420 stores instructions and data for execution by processor 410 when in operation. Device 400 as shown in FIG. 4 also includes mass storage 430 that is also non-transitory in nature. Device 400 of FIG. 4 also includes non-transitory portable storage 440 and input and output devices 450 and 460. Device 400 also includes display 470 and well as peripherals 480.

The aforementioned components of FIG. 4 are illustrated as being connected via a single bus 490. The components of FIG. 4 may, however, be connected through any number of data transport means. For example, processor 410 and memory 420 may be connected via a local microprocessor bus. Mass storage 430, peripherals 480, portable storage 440, and display 470 may, in turn, be connected through one or more input/output (I/O) buses.

Mass storage 430 may be implemented as tape libraries, RAID systems, hard disk drives, solid-state drives, magnetic tape drives, optical disk drives, and magneto-optical disc drives. Mass storage 430 is non-volatile in nature such that it does not lose its contents should power be discontinued. As noted above, mass storage 430 is non-transitory in nature although the data and information maintained in mass storage 430 may be received or transmitted utilizing various transitory methodologies.

Information and data maintained in mass storage 430 may be utilized by processor 410 or generated as a result of a processing operation by processor 410. Mass storage 430 may store various software components necessary for implementing one or more embodiments of the present invention by loading various modules, instructions, or other data components into memory 420.

Portable storage 440 is inclusive of any non-volatile storage device that may be introduced to and removed from hardware device 400. Such introduction may occur through one or more communications ports, including but not limited to serial, USB, Fire Wire, Thunderbolt, or Lightning. While portable storage 440 serves a similar purpose as mass storage 430, mass storage device 430 is envisioned as being a permanent or near-permanent component of the device 400 and not intended for regular removal. Like mass storage device 430, portable storage device 440 may allow for the introduction of various modules, instructions, or other data components into memory 420.

Input devices 450 provide one or more portions of a user interface and are inclusive of keyboards, pointing devices such as a mouse, a trackball, stylus, or other directional control mechanism, including but not limited to touch screens. Various virtual reality or augmented reality devices may likewise serve as input device 450. Input devices may be communicatively coupled to the hardware device 400 utilizing one or more the exemplary communications ports described above in the context of portable storage 440

FIG. 4 also illustrates output devices 460, which are exemplified by speakers, printers, monitors, or other display devices such as projectors or augmented and/or virtual reality systems. Output devices 460 may be communicatively coupled to the hardware device 400 using one or more of the exemplary communications ports described in the context of portable storage 440 as well as input devices 450.

Display system 470 is any output device for presentation of information in visual or occasionally tactile form (e.g., for those with visual impairments). Display devices include but are not limited to plasma display panels (PDPs), liquid crystal displayus (LCDs), and organic light-emitting diode displays (OLEDs). Other displays systems 470 may include surface conduction electron emitters (SEDs), laser TV, carbon nanotubes, quantum dot displays, and interferometric modulator displays (MODs). Display system 570 may likewise encompass virtual or augmented reality devices as well as touch screens that might similarly allow for input and/or output as described above.

Peripherals 480 are inclusive of the universe of computer support devices that might otherwise add additional functionality to hardware device 400 but not otherwise be specifically addressed above. For example, peripheral device 480 may include a modem, wireless router, or otherwise network interface controller. Other types of peripherals 480 might include webcams, image scanners, or microphones although the foregoing might in some instances be considered an input device

The foregoing detailed description has been presented for purposes of illustration and description. The foregoing description is not intended to be exhaustive or to the present invention to the precise form disclosed. Many modifications and variations of the present invention are possible in light of the above description. The embodiments described were chosen in order to best explain the principles of the invention and its practical application to allow others of ordinary skill in the art to best make and use the same. The specific scope of the invention shall be limited by the claims appended hereto.

What is claimed is:

1. A system for developing musical content, the system comprising:
a front-end application executing on a computing device, the front-end application providing an interface to allow users of the computing device to make a musical contribution to a collaborative and socially co-created musical thought;
an application programming interface (API) server that receives the musical contribution from the front-end application and that generates a job ticket for creation of the socially co-created musical thought;
a messaging server that receives the job ticket from the API server and is communicatively coupled to the database, composition server, and production server;
a database that maintains the musical contribution from the front-end application, data related to the generation of the musical contribution, musical blueprints, and rendered musical content all in associated within a job ticket from the messaging server;
a composition server that creates a musical blueprint using the musical contribution; and
a production server that renders musical content using the musical blueprint, the rendered musical content provided through the front-end application for playback and interaction.

2. The system of claim 1, wherein the computing device is a mobile device that hosts and executes the front-end application.

3. The system of claim 1, wherein the computing device is a workstation that hosts and executes the front-end application, the front-end application providing.

4. The system of claim 1, wherein the musical contribution is selected from the group consisting of a melodic “hum,” a rhythmic “tap,” rhythmic “taps,” a melodic “hum” responsive to a rhythmic “tap,” a melodic “hum” responsive to rhythmic “taps,” a rhythmic “tap” responsive to a melodic “hum,” rhythmic “taps” responsive to a melodic “hum,” and a musical thought responsive to an already existing musical collaboration.

5. The system of claim 1, wherein the API server is a hypertext transfer protocol (HTTP) server.

6. The system of claim 5, wherein the API server supports one or more of Python, Tornado, and Apache.

7. The system of claim 5, wherein the API server utilizes the Representational State Transfer (REST) architectural style.

8. The system of claim 1, wherein the API server eliminates any state corresponding to the front-end application contribution once the ticket is passed to the messaging server.

9. The system of claim 1, wherein the messaging server is an advanced message queuing protocol (AMQP) message broker.

10. The system of claim 1, wherein the database utilizes web accessible addresses and is maintained in a cloud storage environment.

11. The system of claim 10, wherein the database further maintains user profiles including user tastes, search preferences, and recommendations.

12. The system of claim 1, further comprising at least one load balancer that distributes traffic to specific instances of auto scaling groups, wherein an autoscaler operates in conjunction with the messaging server to autoscale additional composition and production servers with respect to a number of pending tickets in a messaging queue.

13. The system of claim 1, wherein the messaging server, composition server, and production server execute a respective operation in parallel across a plurality of computing devices.

14. The system of claim 1, wherein the messaging server, composition server, and production server execute multiple processing chains at once.

15. The system of claim 1, wherein the messaging server, composition server, and production server execute to allow for asynchronous musical synthesis.

16. The system of claim 1, further comprising a third-party application executing on a hardware device in communication with one or both of the composition server and production server.

17. The system of claim 1, further comprising a third-party application executing on a hardware device integrated with either of the composition server and production server.

18. The system of claim 1, further comprising a load balancer that distributes network and application traffic to the API server.

19. The system of claim 1, further comprising an autoscaler that manages instances of the composition and production server.
